(19) United States
(12) Patent Application Publication
(10) Pub. No.: US 2004/0168207 A1
(43) Pub. Date: Aug. 26, 2004

(54) Method and apparatus for displaying equivalent announcements

(76) Inventors: Declan Patrick Kelly, Eindhoven (NL); Jozef Pieter Van Gassel, Eindhoven (NL)

Correspondence Address: U S Philips Corporation, Intellectual Property Department, P O Box 3001, Briarcliff Manor, NY, 10510, US

(21) Appl. No.: 10/481,151

(22) PCT Filed: Jun. 20, 2002
(86) PCT No.: PCT/IB02/02394

(30) Foreign Application Priority Data
Jul. 3, 2001 (EP) 01202551.6

(51) Int. Cl. H04N 7/16; H04N 7/00; H04N 11/00

(52) U.S. Cl. 725/139; 725/135; 725/136; 348/461; 348/468

(57) ABSTRACT

The invention relates to a method of forcing a user to view a first announcement, when a user prevents a second announcement, embedded in a stream of audiovisual information, to be shown on a display, where the first announcement and the second announcement are equivalent to each other. The announcement may be a commercial. This prevention can be achieved either by skipping the announcement or by zapping to a different channel. The invention further relates to an apparatus capable of detecting whether a user has viewed an announcement or whether he has skipped it. The apparatus is also capable of displaying a second announcement which is equivalent to the skipped announcement.

The invention relates to a method of displaying a second announcement if a first announcement, embedded in a stream of audiovisual information, is prevented from being displayed on a display screen, said second announcement being equivalent to the first announcement.

The invention also relates to an apparatus comprising means for detecting whether a first announcement, embedded in a stream of audiovisual information, is prevented from being displayed on a display screen, the apparatus further comprising means for displaying a second announcement on a display screen if it is detected that the first announcement is prevented from being displayed, said second announcement being equivalent to the first announcement.

An embodiment of such a method is known from WO 00/01149.

Various short announcements are often transmitted along with the audiovisual information as transmitted by many content providers. The original content, such as a movie, a sports event or a drama series is often interrupted by one or more commercials or short announcements of a different nature. The user often experiences this as a disturbing factor. He will thus do much to prevent such announcements from being displayed. U.S. Pat. No. 5,692,093 describes a device for preventing commercials from being displayed when playing back the recorded content. This is achieved by fast forward winding of the tape with the recorded content at the instant when the commercials are being displayed.

However, for his revenues, the content provider is largely, if not completely dependent on displaying the commercials to the users of his services. Consequently, it is of great importance to the content provider to ensure that the commercials are displayed as frequently as possible to his users.

WO 00/01149 proposes that an alternative commercial is displayed when a user playing back commercials scans through these commercials in a fast manner, which alternative commercial has a content which is equivalent to one or more of the skipped commercials. Since content is increasingly being stored on media on which information can be accessed randomly, such as hard disk systems, it is possible to wind a tape or scan much faster through a given content such as commercials. This implies that there is no time left for displaying alternative equivalent announcements when commercial announcements are skipped during display of the content.

It is an object of the invention to inform the user as yet of the essence of at least one missed announcement. This object is achieved by the method according to the invention, which is characterized in that the second announcement is displayed during display of a first part of the stream of audiovisual information in which the first announcement is not embedded, said first part being chronologically displayed after a second part of the stream of audiovisual information in which the first announcement is embedded.

This method has the advantage that the user is forced to display the announcement on the display screen if he wants to display the rest of the content as well.

An embodiment of the method according to the invention is characterized in that the second announcement is displayed on a first part of the display screen and the first part of the stream of audiovisual information is displayed on a second part of the display screen.

This embodiment has the advantage that the user is not hindered by the announcement when he watches the displayed audiovisual information.

A further embodiment of the method according to the invention is characterized in that the second announcement is displayed on a transparent background on at least a part of the display screen.

This embodiment has the advantage that the user is hindered by the announcement when he watches the displayed audiovisual information and is thus forced to pay his attention to the announcement.

The apparatus according to the invention is characterized in that the apparatus is further adapted to display the second announcement during display of a first part of the stream of audiovisual information in which the first announcement is not embedded, said first part being chronologically displayed after a second part of the stream of audiovisual information in which the first announcement is embedded.

This apparatus has the advantage that the user is forced to display the announcement on the display screen if he wants to display the rest of the content as well.

These and other aspects of the invention are apparent from and will be elucidated with reference to the embodiments described hereinafter.

In the drawings:

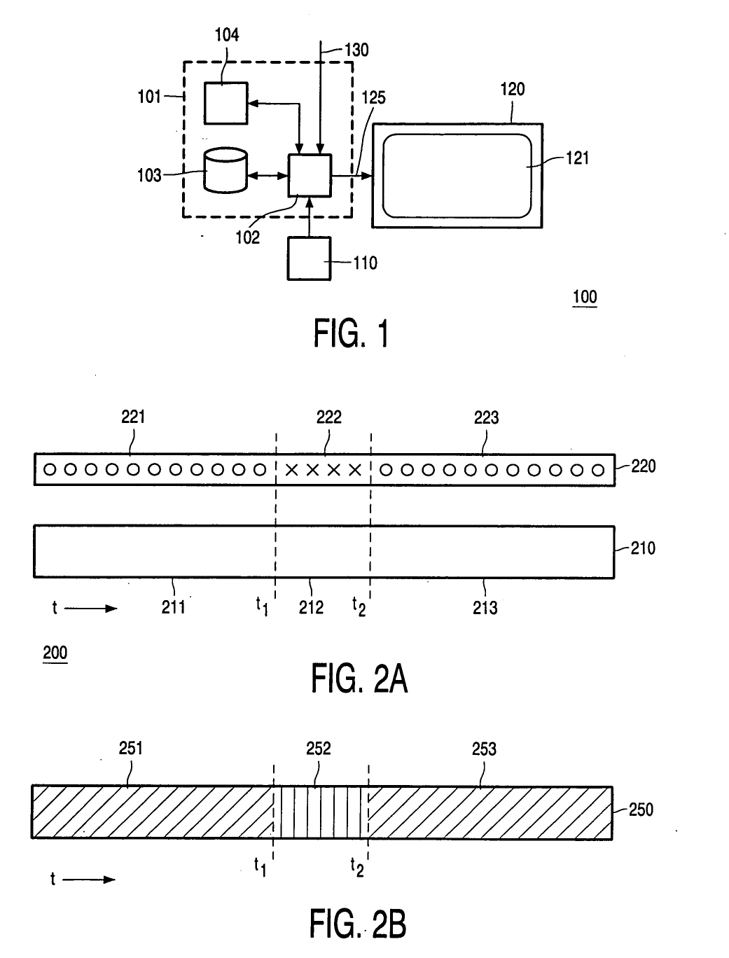

FIG. 1 shows an embodiment of the apparatus according to the invention,

FIG. 2 shows two streams of audiovisual information in which a commercial is embedded,

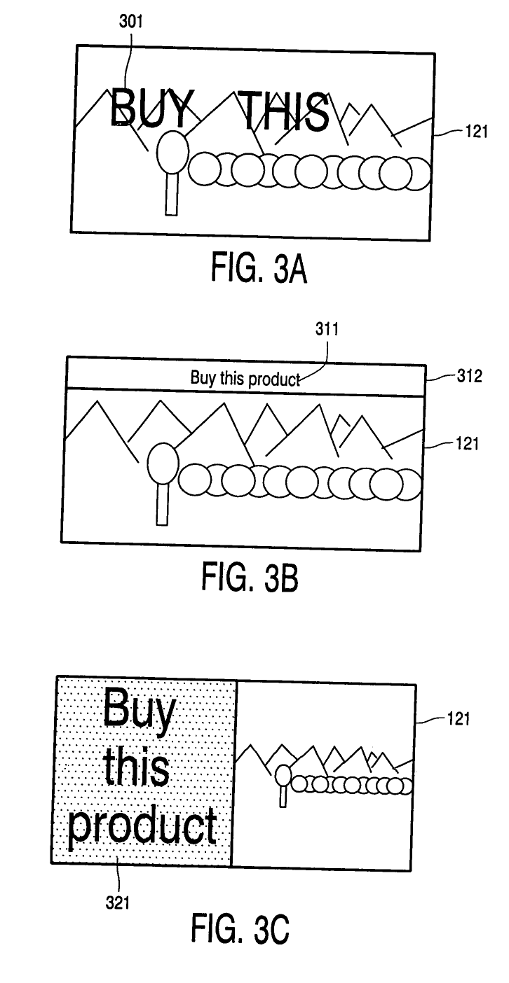

FIG. 3 shows embodiments of the method according to the invention.

FIG. 1 shows a system 100 as an embodiment of the invention, the system comprising an apparatus 101 including a processing unit 102, a first memory 103, a second memory 104 and an input channel 130. The apparatus 101 is preferably a digital video recorder but it may be alternatively an apparatus which is suitable for more purposes, such as a personal computer. The first memory 103 is preferably a hard disk drive or another memory having a large storage capacity. The second memory 104 is preferably a ROM, an EEPROM, a SRAM or another memory which is rapidly accessible. In a further embodiment, it is also possible that the information, which is stored in the second memory 104 in the embodiment described, is stored in the first memory 103. Furthermore, the system 101 comprises an operating panel 110 adapted to control the apparatus 101, and a display device 120 with a display screen 121.

The apparatus 101 is adapted to store audiovisual information presented to the apparatus 101 via the input channel 130 in the first memory 103. This process is controlled by the processing unit 102. This information may be stored by means of a user's command. To this end, the user instructs the apparatus 101 by means of the operating panel 110 to store audiovisual information, presented via the input channel 130, in the first memory 103. The apparatus 101 may also be programmed to store audiovisual information in the first memory 103 at a given instant.

The display device is connected to the processing unit 102 by means of a connection 125. The processing unit 102 is adapted to pass on audiovisual information to the display device 120 via the connection 125, in order that this information can be displayed on the display screen 121 of display device 120. The apparatus 101 can receive the audiovisual information via the input channel 130, or it may be stored in the first memory 103.

Within the apparatus 101, the processing unit 102 is further adapted to process a stream of audiovisual information coming in via the input channel 130 before this information is displayed on the display device or before the stream of audiovisual information is stored in the first memory 103. In a further embodiment of the invention, a stream of audiovisual information, which is stored in the first memory 103, is processed by the processing unit 102 before it is displayed on the display screen 121 of the display device 120.

The audiovisual information is processed on the basis of control information which is stored in the second memory 104. The further information may be stored in the second memory by the manufacturer of the apparatus 101. However, a content provider, who takes care of the audiovisual information, may alternatively transmit the further information and applications along with the audiovisual information which is received by the apparatus 101 via the input channel 130. This is possible within the Multimedia Home Platform (MHP) standard. After the further information has come in via the input channel 130, it is stored in the first memory 103 or in the second memory 104.

FIG. 2A shows a stream of information 200 comprising a first stream of audiovisual information 210 and a stream of accompanying information 220. The two streams of information are synchronized with each other. In the illustrated embodiment of the invention, the first stream of audiovisual information 210 is interrupted by a commercial. It may of course also be an announcement about the weather, coming programs or news but this does not depart from the scope of the invention. A first part 211 of the first stream of audiovisual information 210 represents a first part of a movie, a second part 212 represents the commercial and a third part 213 represents a second part of the movie. The commercial starts at the instant denoted by t₁ in FIG. 2A. The commercial lasts until the instant denoted by t₂ in FIG. 2B. The commercial may be marked by embedding information in the stream of accompanying information 220, which information changes at the instant when the first stream of audiovisual information comprises a commercial. For example, a first part 221 of the stream of accompanying information 220 comprises information stating that the corresponding part 211 of the stream of audiovisual information 210 comprises the first part of the movie. A second part 222 of the stream of accompanying information 220 comprises information stating that the corresponding part 212 of the stream of audiovisual information 210 comprises a commercial. A third part 223 of the stream of accompanying information 220 comprises information stating that the corresponding part 213 of the stream of audiovisual information 210 comprises the second part of the movie. If the stream of information 200 is a stream in accordance with the MPEG standard, the stream of accompanying information can be embedded in the private stream with the MPEG information. This is known per se.

If the stream of audiovisual information cannot be accompanied by another stream of audiovisual information, it is possible to choose a different method of marking commercials in a stream of audiovisual information. FIG. 2B shows a further embodiment of the invention. FIG. 2B shows a stream of audiovisual information 250, a first part 251 of which represents a first part of a movie, a second part 252 represents a commercial and a third part 253 represents a second part of the movie. The commercial is now marked in the stream of audiovisual information 250 by providing the second part 252 of the stream of audiovisual information 250 with a first watermark. This is shown in FIG. 2B by means of the vertical lines in the second part 252 of the stream of audiovisual information 250.

Moreover, the parts of the stream of audiovisual information 250 comprising the movie can be provided with a second watermark. This is indicated in FIG. 2B by means of the diagonal lines in the first part 251 and the third part 253. The provision of a watermark for displaying the content of a stream of audiovisual information has the advantage that no extra stream of information is necessary for marking. The provision of a watermark for displaying the content of a stream of audiovisual information has the further advantage that this form of marking is usually more difficult to remove than a synchronized additional stream of information. The method of watermarking a stream of audiovisual information is known per se.

Since the commercials in a stream of audiovisual information 210 are marked, they can be recognized by the apparatus 101 (FIG. 1) in the illustrated embodiment of the invention. When the apparatus 101 receives the stream of audiovisual information 210 via the input channel 130, this stream will be passed through the processing unit 102 which is adapted to recognize the marking 222 of commercials 212. If the stream of audiovisual information 210 is stored in the first memory 103, the marking of the commercials in the illustrated embodiment of the invention is also stored in the first memory 103.

When a user instructs the system 100 by means of the operating panel 110 to display the stream of audiovisual information 210 on the display screen 121 of the display device 120, the processing unit 102 detects, by way of a marking in the stream of audiovisual information 210 such as a watermark or a marking in an accompanying stream of information 220, whether, for example, a movie or a commercial is being displayed.

In this way, the processing unit 102 can detect whether the whole commercial has been displayed or whether it has been displayed in an accelerated manner, or has not been displayed at all because it has been skipped in the display of the stream of audiovisual information. The commercial may be displayed in an accelerated manner by means of a known method using a fast forward command given to the apparatus 103. A commercial can be skipped when the stream of audiovisual information is stored in a random access memory such as hard disk drive.

The user may zap to another channel when a commercial is being displayed. This can also be detected by the processing unit 102.

In a further embodiment of the invention, it is possible that, by way of the marking of commercials in the stream of audiovisual information, the apparatus 101 does not display commercials when a stream of audiovisual information stored in the first memory 103 is displayed on the display screen 121 of the display device 120. This is possible by instructing the apparatus 101, by means of a command given with the aid of operating panel 110, not to display pieces of audiovisual information whose information is marked as a commercial, by skipping them during display.

Furthermore, several methods of detecting commercials in a stream of audiovisual information and of preventing them from being displayed are known. A method of preventing commercials from being displayed is described in U.S. Pat. No. 5,692,093. A user may also instruct the system 100 in such a way that a commercial is prevented from being displayed on the display screen 121 of the display device 120.

In one embodiment of the invention, alternative commercials are displayed on the display screen 121 of the display device 120 when it is detected that the apparatus 101 is instructed to skip the display of a commercial. To prevent the user from instructing the system 100 to skip the display of these alternative commercials, they are displayed together with the actual content of the stream of audiovisual information. Examples are shown in FIGS. 3A, 3B and 3C. The user will particularly want to watch the movie and take the commercials for granted.

FIG. 3A shows the display screen 121 of the display device 120 (FIG. 1) displaying a stream of audiovisual information. Moreover, a commercial is displayed in the form of a text 301. The text 301 is displayed on the visual part of the stream of audiovisual information by means of techniques which are known per se. The text 301 may be displayed on the full surface area of the display screen 121, but also on a small part of the display screen 121.

FIG. 3B shows the display screen 121 of the display device 120 (FIG. 1) displaying a stream of audiovisual information. Moreover, a bar 312 including a text 311 comprising a commercial is displayed in the upper part of the display screen 121. The text 311 is displayed statically in the illustrated embodiment of the invention, but it is alternatively possible to display the text 311 dynamically like a ticker bar which is known per se.

FIG. 3C shows the display screen 121 of the display device 120 (FIG. 1) displaying a stream of audiovisual information. Moreover, a commercial in the form of a text 321 is displayed on one half of the display screen 121. The method of displaying a text on one half of a display screen and a stream of audiovisual information on the other half is known per se and is used in, for example, the Matchline televisions of Royal Philips Electronics N.V.

The alternative commercial is presented as a text in the embodiments described hereinbefore. In further embodiments, an announcement is presented in the form of images, pictograms or a combination thereof, in combination with a text. In yet another embodiment, the alternative announcement is presented in the form of audiovisual animations, for example, in MacroMedia Flash format.

To detect whether the commercials are displayed on the display screen 121 (FIG. 1) of display device 120 (FIG. 1) or whether the user has prevented this, several applications can be used. For example, these applications can be transmitted along with the stream of audiovisual information which is received by the apparatus 101 (FIG. 1) via the input channel 130 (FIG. 1). In one embodiment of the invention, the audiovisual information is transmitted in accordance with the DVB standard, and these applications can be transmitted along with it in accordance with the MHP standard. In a further embodiment of the invention, the applications are stored in the second memory 104 (FIG. 1), which is a non-volatile memory in this embodiment.

Moreover, the alternative commercials shown in FIG. 3 may also be transmitted along with the stream of audiovisual information in accordance with the MHP standard. This has the advantage that the most topical commercial is always shown to a user. The alternative commercial can be transmitted to the apparatus 101 (FIG. 1) at the instant when the first commercial is prevented from being displayed. In a further embodiment of the invention, the alternative commercial has already been transmitted to the apparatus 101 (FIG. 1) at an earlier stage and stored in the second memory 104 (FIG. 1).

The current MHP standard has the problem that an application may be interrupted or cut off when a user selects a different channel. For example, the application which must detect whether a user has viewed or not viewed a commercial is cut off because the user has selected a different channel. The user may thus start a new application which is transmitted along with an audiovisual stream of information transmitted on the other channel. If the invention is implemented by means of the MHP standard and if the content provider is to be sure of an optimal range of the transmitted commercials, co-operation between different content providers is important. In this way, it can be arranged that applications transmitted along with a channel are not cut off when the user zaps to another channel.

In summary, the invention relates to a method of forcing a user to view a first announcement, when a user prevents a second announcement, embedded in a stream of audiovisual information, to be shown on a display, where the first announcement and the second announcement are equivalent to each other. The announcement may be a commercial. This prevention can be achieved either by skipping the announcement or by zapping to a different channel. The invention further relates to an apparatus capable of detecting whether a user has viewed an announcement or whether he has skipped it. The apparatus is also capable of displaying a second announcement which is equivalent to the skipped announcement.

1. A method of displaying a second announcement (301) if a first announcement (212), embedded in a stream of audiovisual information (210), is prevented from being displayed on a display screen (121), said second announcement (301) being equivalent to the first announcement (212), characterized in that the second announcement (301) is displayed during display of a first part of the stream of audiovisual information (210) in which the first announcement (212) is not embedded, said first part being chronologically displayed after a second part of the stream of audiovisual information (210) in which the first announcement (212) is embedded.

2. A method as claimed in claim 1, characterized in that the second announcement (321) is displayed on a first part of the display screen (121) and the first part of the stream of audiovisual information is displayed on a second part of the display screen (121).

3. A method as claimed in claim 2, characterized in that the first part of the display screen and the second part of the display screen are complementary.

4. A method as claimed in claim 2, characterized in that the first part of the display screen is a bar (312) along an edge of the display screen (121).

5. A method as claimed in claim 1, characterized in that the second announcement (301) is displayed on a transparent background on at least a part of the display screen (121).

6. A method as claimed in claim 1, characterized in that the second announcement is embedded in a data stream coupled to the stream of audiovisual information (210).

7. A method as claimed in claim 6, characterized in that the data stream is adapted in accordance with the Multimedia Home Platform standard.

8. An apparatus (101) comprising means for detecting whether a first announcement (212), embedded in a stream of audiovisual information (210), is prevented from being displayed on a display screen (121), the apparatus further comprising means for displaying a second announcement (301) on a display screen (121) if it is detected that the first announcement (212) is prevented from being displayed, said second announcement (301) being equivalent to the first announcement (212), characterized in that the apparatus (101) is further adapted to display the second announcement (301) during display of a first part of the stream of audiovisual information (210) in which the first announcement (212) is not embedded, said first part being chronologically displayed after a second part of the stream of audiovisual information (210) in which the first announcement (212) is embedded.

9. An apparatus (101) as claimed in claim 8, characterized in that the apparatus (101) is further adapted to receive a data stream in which the second announcement (301) is embedded.

10. An apparatus (101) as claimed in claim 9, characterized in that the apparatus (101) is further adapted to receive a data stream in which the second announcement (301) is embedded, and is adapted in accordance with the MHP standard.
